(19) United States
(12) Patent Application Publication
(10) Pub. No.: US 2023/0229913 A1
(43) Pub. Date: Jul. 20, 2023

(54) Method and Apparatus for Training Information Adjustment Model of Charging Station, and Storage Medium

(71) Applicant: Beijing Baidu Netcom Science Technology Co., Ltd., Beijing (CN)

(72) Inventors: Weijia ZHANG, Beijing (CN); Le ZHANG, Beijing (CN); Hao LIU, Beijing (CN); Jindong HAN, Beijing (CN); Chuan QIN, Beijing (CN); Hengshu ZHU, Beijing (CN); Hui XIONG, Beijing (CN)

(21) Appl. No.: 18/125,327

(22) Filed: Mar. 23, 2023

(30) Foreign Application Priority Data
Aug. 10, 2022 (CN) 202210955011.X

(51) Int. Cl. G06N 3/08

(52) U.S. Cl. CPC G06N 3/08

(57) ABSTRACT

A method and apparatus for training an information adjustment model of a charging station, an electronic device, and a storage medium are provided. An implementation comprises: acquiring a battery charging request, and determining environment state information corresponding to each charging station in a charging station set; determining, through an initial policy network, target operational information of each charging station in the charging station set for the battery charging request, according to the environment state information; determining, through an initial value network, a cumulative reward expectation corresponding to the battery charging request according to the environment state information and the target operational information; training the initial policy network and the initial value network by using a deep deterministic policy gradient algorithm; and determining the trained policy network as an information adjustment model corresponding to each charging station.

### CROSS-REFERENCE TO RELATED APPLICATIONS

This application claims priority to Chinese Patent Application No. 202210955011.X, filed with the China National Intellectual Property Administration (CNIPA) on Aug. 10, 2022, the content of which is incorporated herein by reference in its entirety.

### TECHNICAL FIELD

The present disclosure relates to the field of artificial intelligence technology, particular to the field of multi-agent reinforcement learning technology, and more particular to a method and apparatus for training an information adjustment model of a charging station, a method and apparatus for selecting a charging station, an electronic device, and a storage medium, and may be applied to a scenario of charging at a charging station.

### BACKGROUND

As society pays more and more attention to clean energy and environmental protection issues, rechargeable vehicles have begun to become the choice of more and more people. Although many public charging stations have been built in cities to meet the growing battery charging demand, these charging stations generally perform a unified dynamic price adjustment at intervals of a fixed time (e.g., 1 hour), and generally face the problems of unbalanced battery charging demand and low utilization rate, which makes the battery charging experience of the drivers of the rechargeable vehicles poor. The low utilization rate of the charging stations also hinders the construction of operators for charging stations and hinders the further popularization of rechargeable vehicles.

### SUMMARY

Embodiments of the present disclosure provide a method and apparatus for training an information adjustment model of a charging station, a method and apparatus for selecting a charging station, an electronic device, and a storage medium.

According to a first aspect, some embodiments of the present disclosure provide a method for training an information adjustment model of a charging station. The method includes: acquiring a battery charging request, and determining environment state information corresponding to each charging station in a charging station set; determining, through an initial policy network, target operational information of the each charging station in the charging station set for the battery charging request, according to the environment state information corresponding to the each charging station in the charging station set; determining, through an initial value network, a cumulative reward expectation corresponding to the battery charging request according to the environment state information and the target operational information corresponding to the each charging station in the charging station set; training the initial policy network and the initial value network by using a deep deterministic policy gradient algorithm, to obtain a trained policy network and a trained value network, wherein, during the training, the initial value network is updated through a temporal difference method, and the initial policy network is updated with a goal of maximizing the cumulative reward expectation corresponding to the battery charging request; and determining the trained policy network as an information adjustment model corresponding to the each charging station in the charging station set.

According to a second aspect, some embodiments of the present disclosure provide a method for selecting a charging station. The method includes: acquiring a battery charging request; determining environment state information corresponding to each charging station in a charging station set; for the each charging station in the charging station set, determining, through a trained information adjustment model corresponding to the each charging station, target operational information of the each charging station for the battery charging request according to the environment state information of the charging station, wherein, on a basis that charging stations in the charging station set perceive environment state information of each other, the trained information adjustment model is obtained by performing multi-agent reinforcement learning based on a deep deterministic policy gradient algorithm; displaying the target operational information of the each charging station in the charging station set for the battery charging request; and receiving a selection instruction and determining a target charging station from the charging station set according to the selection instruction.

According to a third aspect, some embodiments of the present disclosure provide an apparatus for training an information adjustment model of a charging station. The apparatus includes: a first determining unit, configured to acquire a battery charging request, and determine environment state information corresponding to each charging station in a charging station set; a second determining unit, configured to determine, through an initial policy network, target operational information of the each charging station in the charging station set for the battery charging request, according to the environment state information corresponding to the each charging station in the charging station set; a third determining unit, configured to determine, through an initial value network, a cumulative reward expectation corresponding to the battery charging request according to the environment state information and the target operational information corresponding to the each charging station in the charging station set; a training unit, configured to train the initial policy network and the initial value network by using a deep deterministic policy gradient algorithm, to obtain a trained policy network and a trained value network, wherein, during the training, the initial value network is updated through a temporal difference method, and the initial policy network is updated with a goal of maximizing the cumulative reward expectation corresponding to the battery charging request; and a fourth determining unit, configured to determine the trained policy network as an information adjustment model corresponding to the each charging station in the charging station set.

According to a fourth aspect, some embodiments of the present disclosure provide an apparatus for selecting a charging station. The apparatus includes: an acquiring unit, configured to acquire a battery charging request; a fifth determining unit, configured to determine environment state information corresponding to each charging station in a charging station set; a sixth determining unit, configured to determine through a trained information adjustment model corresponding to the each charging station, for the each charging station in the charging station set, target operational information of the each charging station for the battery charging request according to the environment state information of the charging station, wherein, on a basis that charging stations in the charging station set perceive environment state information of each other, the trained information adjustment model is obtained by performing multi-agent reinforcement learning based on a deep deterministic policy gradient algorithm; a displaying unit, configured to display the target operational information of the each charging station in the charging station set for the battery charging request; and a receiving unit, configured to receive a selection instruction and determine a target charging station from the charging station set according to the selection instruction.

According to a fifth aspect, some embodiments of the present disclosure provide an electronic device. The electronic device includes: at least one processor; and a storage device, in communication with the at least one processor, wherein the storage device stores instructions which, when executed by the at least one processor, cause the at least one processor to perform the method according to any one of the implementations described in the first and/or second aspect.

According to a sixth aspect, some embodiments of the present disclosure provide a non-transitory computer readable storage medium. The non-transitory computer readable storage medium stores a computer instruction, wherein the computer instruction is used to cause the computer to perform the method according to any one of the implementations described in the first and/or second aspect.

It should be understood that the content described in this part is not intended to identify key or important features of embodiments of the present disclosure, and is not used to limit the scope of the present disclosure. Other features of the present disclosure will be easily understood through the following description.

### BRIEF DESCRIPTION OF THE DRAWINGS

The accompanying drawings are used for a better understanding of the scheme, and do not constitute a limitation to the present disclosure.

FIG. 1 is a diagram of an example system architecture in which an embodiment of the present disclosure may be applied;

FIG. 2 is a flowchart of a method for training an information adjustment model of a charging station according to an embodiment of the present disclosure;

FIG. 3 is a schematic diagram of an application scenario of the method for training an information adjustment model of a charging station according to an embodiment of the present disclosure;

FIG. 4 is a schematic diagram of a processing flow of an agent pooling module according to an embodiment of the present disclosure;

FIG. 5 is a schematic diagram of a selection for a subset from a charging station set according to this embodiment;

FIG. 6 is a flowchart of the method for training an information adjustment model of a charging station according to an embodiment of the present disclosure;

FIG. 7 is a flowchart of a method for selecting a charging station according to an embodiment of the present disclosure;

FIG. 8 is a structural diagram of an apparatus for training an information adjustment model of a charging station according to an embodiment of the present disclosure;

FIG. 9 is a structural diagram of an apparatus for selecting a charging station according to an embodiment of the present disclosure; and

FIG. 10 is a schematic structural diagram of a computer system adapted to implement embodiments of the present disclosure.

### DETAILED DESCRIPTION

Example embodiments of the present disclosure are described below in combination with the accompanying drawings, and various details of the embodiments of the present disclosure are included in the description to facilitate understanding, and should be considered as examples only. Accordingly, it should be recognized by one of ordinary skill in 5 the art that various changes and modifications may be made to the embodiments described herein without departing from the scope and spirit of the present disclosure. Also, for clarity and conciseness, descriptions for well-known functions and structures are omitted in the following description.

In the technical solution described in embodiments of the present disclosure, the collection, storage, use, processing, transmission, provision, disclosure, etc. of the personal information of a user all comply with the provisions of the relevant laws and regulations, and do not violate public order and good customs.

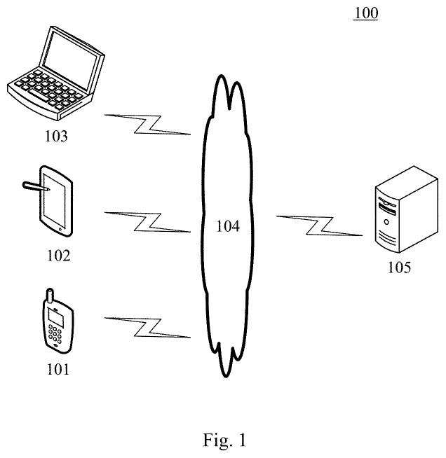

FIG. 1 illustrates an example architecture 100 in which a method and apparatus for training an information adjustment model of a charging station and a method and apparatus for selecting a charging station according to embodiments of the present disclosure may be applied.

As shown in FIG. 1, the system architecture 100 may include terminal device(s) 101, 102, 103, a network 104 and a server 105. The communication connections among the terminal devices 101, 102 and 103 constitute a topological network. The network 104 serves as a medium providing a communication link between the terminal device(s) 101, 102, 103 and the server 105. The network 104 may include various types of connections, for example, wired or wireless communication links, or optical fiber cables.

The terminal device(s) 101, 102, 103 may be hardware device(s) or software supporting a network connection for data interaction and data processing. When being hardware, the terminal device(s) 101, 102, 103 may be various electronic devices supporting a network connection and functions such as information acquisition, interaction, display and processing functions, the electronic devices including, but not limited to, a smartphone, a tablet computer, a vehicle-mounted computer, an e-book reader, a laptop portable computer, a desktop computer, and the like. When being the software, the terminal device(s) 101, 102, 103 may be installed in the above electronic devices. The terminal devices may be implemented as a plurality of pieces of software or a plurality of software modules (e.g., software or software modules for providing a distributed service), or may be implemented as a single piece of software or a single software module, which will not be specifically limited here.

The server 105 may be a server providing various services. As an example, the server 105 may be a backend processing server that performs, according to the training samples provided by the terminal device(s) 101, 102, 103, multi-agent reinforcement learning using a deep deterministic policy gradient algorithm, to obtain a trained information adjustment model corresponding to each charging station. As another example, the server 105 may be a backend processing server that, for a target charging station, determines, according to a battery charging request provided by the terminal device 101, 102 or 103, the target operational information for the battery charging request is determined through an information adjustment model corresponding to the target charging station, for a user to select a target charging station from a charging station set according to the target operational information. As an example, the server 105 may be a cloud server.

It should be noted that the server may be hardware or software. When being the hardware, the server may be implemented as a distributed server cluster composed of a plurality of servers, or may be implemented as a single server. When being the software, the server may be implemented as a plurality of pieces of software or a plurality of software modules (e.g., software or software modules for providing a distributed service), or may be implemented as a single piece of software or a single software module, which will not be specifically limited here.

It should also be noted that the method for training an information adjustment model of a charging station and the method for selecting a charging station that are provided in embodiments of the present disclosure may be performed by the server, by the terminal device(s), or by the server and the terminal device(s) that are in collaboration with each other. Correspondingly, the parts (e.g., the units) included in the apparatus for training an information adjustment model of a charging station and the apparatus for selecting a charging station may be all provided in the server, all provided in the terminal device(s), or separately provided in the server and the terminal device(s).

It should be appreciated that the numbers of the terminal device(s), the network(s) and the server(s) in FIG. 1 are merely illustrative. Any number of terminal device(s), network(s) and server(s) may be provided based on actual requirements. When an electronic device on which the method for training an information adjustment model of a charging station and the method for selecting a charging station run does not need to perform data transmission with another electronic device, the system architecture may only include the electronic device (e.g., a server or a terminal device) on which the method for training an information adjustment model of a charging station and the method for selecting a charging station run.

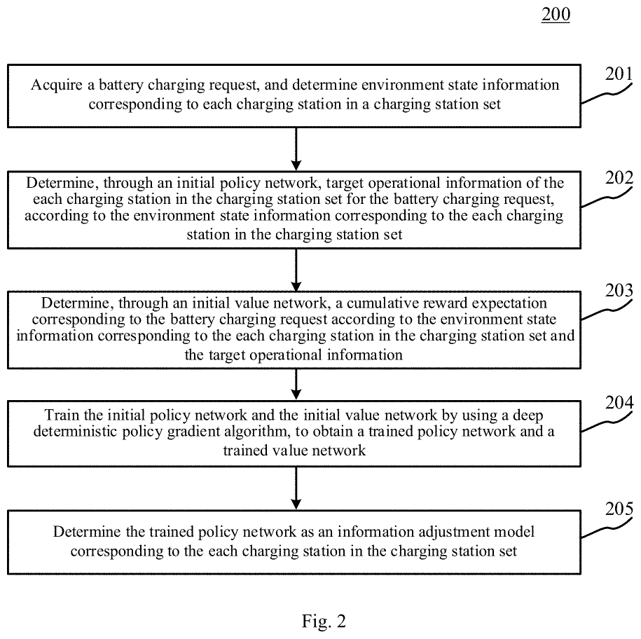

Referring to FIG. 2, FIG. 2 is a flowchart of a method for training an information adjustment model of a charging station provided by an embodiment of the present disclosure. Here, the flow 200 includes the following steps:

Step 201, acquiring a battery charging request, and determining environment state information corresponding to each charging station in a charging station set.

In this embodiment, an executing body (e.g., the terminal device(s) or the server in FIG. 1) of the method for training an information adjustment model of a charging station may acquire, by means of a wired network connection or wireless network connection, the battery charging request remotely or locally, and determine the environment state information corresponding to each charging station in the charging station set.

The battery charging request may be a request that is sent by a user of a rechargeable vehicle through a terminal device such as a smartphone or a vehicle-mounted computer, and represents that the rechargeable vehicle needs to be charged. When the rechargeable vehicle has a battery charging demand, a corresponding user such as a driver or a passenger will initiate a battery charging request at a charging platform. A battery charging request qₜ is defined as a t-th request in one day. The battery charging request qₜ includes the following attributes: the location lₜ at which the battery charging request qₜ is sent, the time Tₜ at which the battery charging request qₜ is sent, and the time T′ₜ at which qₜ is completed (when the rechargeable vehicle corresponding to the battery charging request is successfully charged or fails to be charged, it is considered that the battery charging request is completed).

For the received battery charging request, target operational information of each charging station in the charging station set may be sent to the user, such that the user may select a charging station from the charging station set according to the target operational information fed back.

Step 202, determining, through an initial policy network, target operational information of the each charging station in the charging station set for the battery charging request, according to the environment state information corresponding to the each charging station in the charging station set.

In this embodiment, through the initial policy network, the above executing body may determine the target operational information of the each charging station in the charging station set for the battery charging request, according to the environment state information corresponding to the each charging station in the charging station set.

The target operational information may be any operational information that can be adjusted by the charging station in operation. As an example, the target operational information may be the operational information of the charging station such as pricing information, battery charging time information, and battery charging speed information.

The pricing information is took as an example, which may be a battery charging unit-price. The battery charging unit-price represents a battery charging price per kilowatt-hour (kWh) of the charging station, including an electricity unit-price per kilowatt-hour (kW h) and a service unit-price of the charging station. When the battery charging request qₜ is successfully serviced by the charging station, i.e., the battery charging is successful at the charging station, the profit of the charging station for this battery charging service of the battery charging request qₜ is defined as:

profit=(charging unit-price−electricity unit-price)×charging volume

Further, the total profit of the plurality of charging stations in the charging station set is a sum of profits corresponding to all battery charging requests.

The charging station set includes a plurality of charging stations. As an example, the charging station set refers to all charging stations in a preset partitioned region (e.g., obtained by partitioning according to administrative regions or according to specified areas). Each charging station may be regarded as an agent. A charging station set C includes N charging stations cⁱ ∈ C.

For each charging station cⁱ, the environment state information of the charging station relative to the battery charging request qₜ may be considered as an observation for the charging station cⁱ, including information representing the charging station cⁱ and information representing a correlation between the battery charging request qₜ and the charging station cⁱ. As an example, for the battery charging request qₜ, the environment state information of the charging station cⁱ includes: current time Tₜ, the number of current idle charging spots at the charging station cⁱ, the number of battery charging requests in a future preset time period (e.g., 15 minutes) in the vicinity of the charging station cⁱ (a trained prediction model may be used to predict the number of battery charging requests in the future), the estimated traveling time from the location of a current battery charging request to the charging station cⁱ, the charging power of the charging station cⁱ, a current electricity unit-price of cⁱ, and the number of rechargeable vehicles that are heading for cⁱ (which can be acquired through a charging platform application).

In this embodiment, an actor (policy network)-critic (value network) architecture is used. Here, the policy network is used to determine action information according to the environment state information corresponding to the each charging station in the charging station set, i.e., the target operational information of the each charging station in the charging station set for the battery charging request.

As an example, Oₜ={oₜ¹, oₜ², . . . , oₜ^{N}} is defined as a joint observation (joint environment state information) of all agents at a t-th step (i.e., a t-th battery charging request), and Oₜ is inputted into the policy network to obtain the target operational information aₜⁱ of the each charging station in the charging station set for the battery charging request.

For each charging station in the charging station set, the current observation oₜⁱ is given, each charging station cⁱ simultaneously performs a continuous action aₜⁱ, i.e., real-time target operational information provided by the charging station cⁱ for the battery charging request qₜ. Here, the joint action of all agents is defined as Aₜ={aₜ¹, aₜ², . . . , aₜ^{N}}. Each charging station cⁱ determines corresponding target operational information aₜⁱ. According to the target operational information of each charging station, the user sending the battery charging request qₜ may select an appropriate charging station for battery charging. The process of changing from the status Sₜ corresponding to the battery charging request qₜ to the status Sₜ₊₁ associated with a next battery charging request qₜ₊₁ may be considered as a state transition. With the state transition, the environment state information oₜⁱ of each charging station cⁱ in the charging station set is transferred to oₜ₊₁ⁱ.

Here, the policy network may adopt a deep neural network, for example, a network model such as a deep convolutional network or a residual network.

Step 203, determining, through an initial value network, a cumulative reward expectation corresponding to the battery charging request according to the environment state information and the target operational information corresponding to the each charging station in the charging station set.

In this embodiment, through the initial value network, the above executing body may determine the cumulative reward expectation corresponding to the charging request according to the environment state information and the target operational information corresponding to the each charging station in the charging station set. The cumulative reward expectation may be considered as a score for the target operational information of the charging station determined by the policy network. A higher numeric value represents better target operational information of the policy network.

As an example, X_{D, t}=[Oₜ∥Aₜ] is defined as a joint feature obtained by concatenating the joint observation Oₜ and the joint action Aₜ of all the charging stations. The joint feature X_{D, t} is inputted into the initial value network to obtain the cumulative reward expectation corresponding to the battery charging request.

The goal of all the charging stations in the charging station set is to maximize the cumulative reward Rₜ of all battery charging request sets [symbol] in one day:

Rₜ=Σ_{t′=1} [symbol] γ^{t′-t}r_{t′}.

Here, γ denotes a discount rate and r_{t′} denotes a corresponding reward.

The cumulative reward expectation is the expected value of the cumulative reward Rₜ.

In this embodiment, the value network may adopt a deep neural network, for example, a network model such as a deep convolutional network or a residual network. Here, the value network may adopt the same network structure as that of the policy network, or may adopt a network structure different from that of the policy network.

Step 204, training the initial policy network and the initial value network by using a deep deterministic policy gradient algorithm, to obtain a trained policy network and a trained value network.

In this embodiment, the above executing body may train the initial policy network and the initial value network by using the deep deterministic policy gradient algorithm, to obtain the trained policy network and the trained value network. Here, during the training, the initial value network is updated through a temporal difference method, and the initial policy network is updated with a goal of maximizing the cumulative reward expectation corresponding to the battery charging request.

The deep deterministic policy gradient (DDPG) algorithm is a policy learning method which integrates a deep learning neural network into a DPG (deterministic policy gradient). Compared with the DPG algorithm, the DDPG algorithm adopts a deep neural network as a simulation of a policy function and a value function. Then, the policy function and the value function are trained using a deep learning method.

As an example, for each battery charging request qₜ, the target operational information of the each charging station in the charging station set for the battery charging request and the cumulative reward expectation corresponding to the battery charging request are determined by performing steps 202 and 203. Then, the initial value network is updated through the temporal difference (TD) method, and for the updated initial value network, the initial policy network is updated with the goal of maximizing the cumulative reward expectation corresponding to the battery charging request, to obtain the updated initial policy network. For each battery charging request, the above training process is iteratively performed until a preset termination condition is reached, thus obtaining the trained policy network and the trained value network. Here, the preset termination condition may be, for example, that the training time length exceeds a preset time length threshold, that the number of training exceeds a preset number threshold, and/or that a training loss tends to converge.

Step 205, determining the trained policy network as an information adjustment model corresponding to the each charging station in the charging station set.

In this embodiment, the above executing body may determine the trained policy network as the information adjustment model corresponding to the each charging station in the charging station set.

As an example, an information adjustment model may be deployed in each charging station in the charging station set, to determine the target operational information in real time according to the received battery charging request.

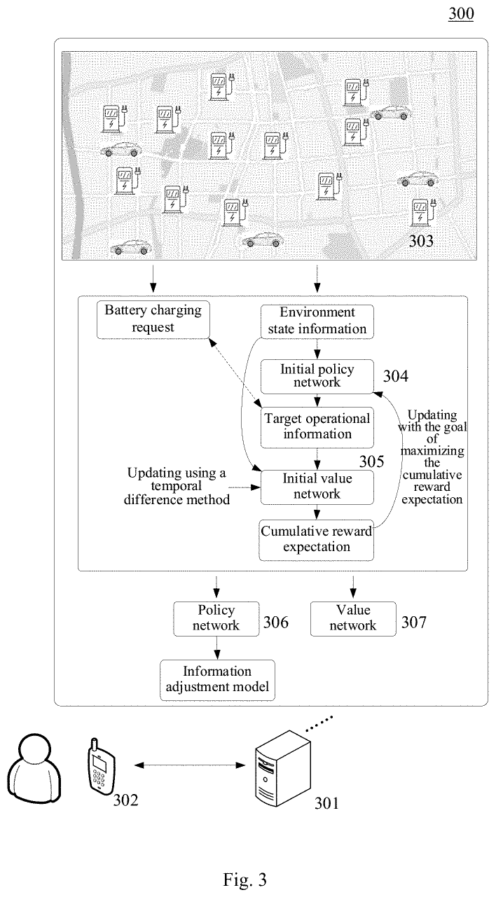

Further referring to FIG. 3, FIG. 3 is a schematic diagram 300 of an application scenario of the method for training an information adjustment model of a charging station according to an embodiment. In the application scenario of FIG. 3, first, a server 301 acquires a battery charging request from a terminal device 302, and determines environment state information corresponding to each charging station in a charging station set 303. Then, through an initial policy network 304, the server 301 determines target operational information of the each charging station in the charging station set for the battery charging request, according to the environment state information corresponding to the each charging station in the charging station set 303. Through an initial value network 305, the server 301 determines a cumulative reward expectation corresponding to the battery charging request according to the environment state information corresponding to the each charging station in the charging station set 303 and the target operational information. The server 301 trains the initial policy network and the initial value network by using a deep deterministic policy gradient algorithm, to obtain a trained policy network 306 and a trained value network 307. Here, during the training, the initial value network is updated through a temporal difference method, and the initial policy network is updated with the goal of maximizing the cumulative reward expectation corresponding to the battery charging request. The server 301 determines the trained policy network 306 as an information adjustment model corresponding to the each charging station in the charging station set.

In this embodiment, a method for training an information adjustment model of a charging station is provided. A charging station is used as an agent, and multi-agent reinforcement learning is performed based on a deep deterministic policy gradient algorithm, to train and obtain a policy network, that can determine target operational information in real time, as an information adjustment model, thereby improving the real-time performance and rationality of the charging station in determining the target operational information. In the model training phase, the goal is to maximize the cumulative reward of the charging station set as a whole, and thus the agents can perceive each other and the whole environment information, which improves the coordination among the charging stations in the charging station set and helps to solve the problem of uncoordinated battery charging among the charging stations, thereby improving the utilization rate of the charging stations.

In some alternative implementations of this embodiment, the above executing body may perform the above step 203 by:

first, determining, through an agent pooling module, integrated representation information representing all charging stations in the charging station set according to the environment state information and the target operational information corresponding to the each charging station in the charging station set; and second, determining, through the initial value network, the cumulative reward expectation corresponding to the battery charging request according to the integrated representation information.

For a training process for a large scale of charging stations in a centralized manner, a joint observation Oₜ and a joint action Aₜ of all the charging stations are related, and the dimensions of the joint observation Oₜ and the joint action Aₜ increase with the increase of the number of the charging stations. In a large-scale agent system, the centralized training approach will encounter a problem of dimensional explosion, resulting in a poor training effect. Therefore, a dimension reduction may be performed on the joint observation Oₜ and the joint action Aₜ through the agent pooling (AP) module, to solve the problem of vector dimension explosion caused by too many agents in the centralized training process.

In this implementation, the dimension reduction is performed on the environment state information and the target operational information corresponding to all the charging stations in the charging station set through the agent pooling module, to solve the problem of vector dimension explosion caused by too many charging stations in the centralized training process, which improves the applicability and the training efficiency of the training process.

In some alternative implementations of this embodiment, the above executing body may perform the first step by: first, mapping, through a mapping vector, the environment state information and the target operational information corresponding to the each charging station in the charging station set to a score feature representing an importance of the charging station; then, determining a preset number of charging stations from the charging station set according to the score feature, and determining environment state information, target operational information and a score feature corresponding to the preset number of charging stations; then, normalizing the score feature corresponding to the preset number of charging stations to obtain a gate control vector; then, determining a gate control feature according to the environment state information, the target operational information and the gate control vector corresponding to the preset number of charging stations; and determining the integrated representation information of all the charging stations in the charging station set according to the gate control feature.

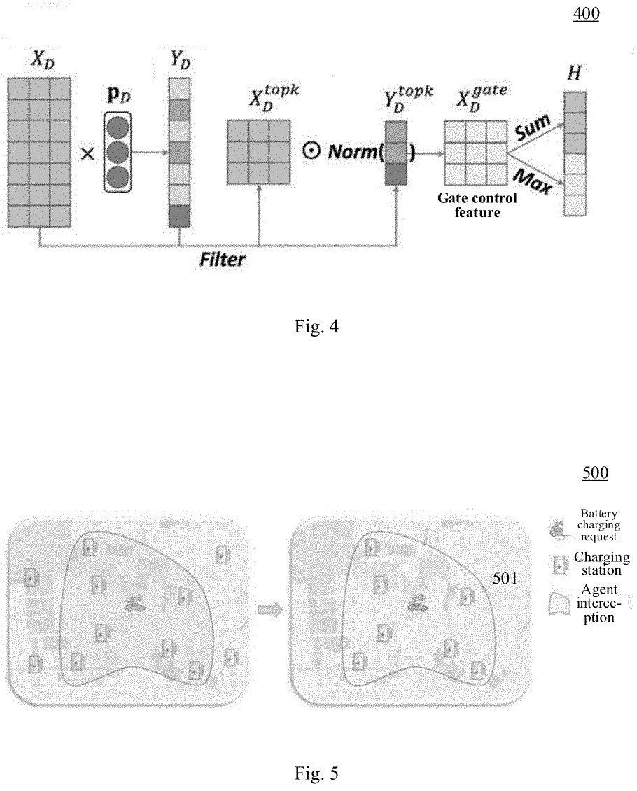

As shown in FIG. 4, FIG. 4 is a schematic diagram of a processing flow of an agent pooling module. X_{D}=[0∥A] is defined as a joint feature obtained by concatenating a joint observation and a joint action of all charging stations. Through a learnable agent pooling module, the important information of the charging stations in a charging station set is distilled into a potential representation, and redundant information is removed at the same time. It should be noted that the following operations are assumed to be completed in a t-th step. The subscript t is omitted in order to simplify the notations.

First, through the following formula, the projection of X_{D} into a score feature (which may be an importance score) representing the importance of a charging station is learned, for the selection of a charging station in the charging station set C.

Y_{D}=X_{D}p_{D}

Here, p_{D} is a learnable mapping vector.

Then, the most important first top-k charging stations are selected based on the score feature Y_{D}, and other charging stations are discarded, to implement the screening and filtering for the charging stations.

X_{D}^{topk}, Y_{D}^{topk}=Filter(X_{D},Y_{D},kₕ)

Here, Y_{D}^{topk} denotes top-k maximum importance scores, X_{D}^{topk}denotes a joint feature of charging stations corresponding to the top-k importance scores one by one, kₕ denotes numerical values corresponding to top-k, and Filter denotes screening and filtering.

Then, a gate control mechanism is employed to control the retention of knowledge through the following formula:

X_{D}^{gate}=X_{D}^{topk}⊙Norm(Y_{D}^{topk}).

Here, Y_{D}^{topk} is normalized into a gate control vector, and ⊙ denotes a Hadamard product. Here, Softmax is selected as a normalization function Norm. It should be noted that the gate control mechanism may cause the gradient energy to flow into a projection vector p_{D}, such that p_{D} can perform learning by back propagation. The resulting gate control feature

$${X}_{D}^{gate} = \{ {x}_{D}^{1 , gate} , … , {x}_{D}^{{N}_{topk} , gate} \}$$

is obtained.

Finally, the integrated representation information of the charging station set C after the dimension reduction is obtained according to the gate control feature X_{D}^{gate} through the following formula:

$$H = ( {\sum }_{i = 1}^{{N}_{topk}} {x}_{D}^{i , gate} ) \vert \vert ( {max}_{i = 1}^{{N}_{topk}} {x}_{D}^{i , gate} ) .$$

Here, ∥ denotes a vector concatenating operation.

In this implementation, a specific operation flow of an agent pooling module is provided. An important charging station relative to the battery charging request is determined based on the screening and filtering for the charging stations. The retention of the knowledge is controlled based on the gate control mechanism, which further improves the accuracy of the integrated representation information determined by the agent pooling module and the training efficiency of the training process.

In some alternative implementations of this embodiment, the above executing body may perform the above step 204 through the following approach:

First, a first loss corresponding to the initial value network is determined through the temporal difference method.

The temporal difference methods includes the Sarsa method of on-policy and the Q-Learning method of off-policy. In this implementation, the first loss corresponding to the initial value network may be determined by any of the temporal difference methods.

Second, a second loss corresponding to the agent pooling module is determined through a self-supervised contrastive learning method.

Here, one query instance H_{q}, one positive instance H₊ and K−1 negative instances H₋={H₋¹, . . . , H₋^{K-1}} are given. The self-supervised contrastive learning is intended to make the degree of matching between the query instance H_{q} and the positive instance H₊ higher than the degree of matching between the query instance H_{q} and any negative instance H₋ⁱ∈ H₋, to facilitate the learning of a more discriminated representation of the instance.

In this implementation, the integrated representation information corresponding to the charging station set represented by the agent pooling module may be used as a query instance, and a positive instance and negative instances corresponding to the integrated representation information may be determined, to determine a self-supervised contrastive learning loss InfoNCE between the integrated representation information and the corresponding positive and negative instances as the second loss.

Third, the initial value network and the agent pooling module are updated according to the first loss and the second loss.

In this implementation, the above executing body may determine a total loss according to the first loss and the second loss based on a summation or a weighted summation manner, and the like, and then determine a gradient according to the total loss to update the initial value network and the agent pooling module according to a gradient descent method.

Fourth, the initial policy network is updated with the goal of maximizing the cumulative reward expectation corresponding to the battery charging request.

In this implementation, the learning goal of the policy network u is to maximize the following cumulative reward expectation:

J(θ^{u})= [symbol] _{O}_{ₜ}_{˜D}[Q(Hₜ)|ₐ_{ₜ}_{ⁱ}₌ᵤ₍ₒ_{ₜ}_{ⁱ}₎].

Here, Du denotes a training sample set, θ^{u} denotes a parameter of the policy network u, Q denotes a value network, and Hₜ denotes integrated representation information of charging stations in a charging station set corresponding to a battery charging request qₜ. The training sample set may include a joint observation, a joint action, and reward information of all the charging stations.

In this implementation, the detailed processes of training the policy network, the pooling module, and the value network are provided, which helps to improve the accuracy of the trained policy network, the trained pooling module, and the trained value network.

In some alternative implementations of this embodiment, the above executing body may perform the above second step by:

first, determining, for a first subset in a joint feature, first integrated representation information through the agent pooling module, wherein the joint feature comprises the environment state information and the target operational information corresponding to the each charging station in the charging station set; then, determining, for a second subset in the joint feature, second integrated representation information through the agent pooling module; then, determining, for a third subset in a joint feature corresponding to another battery charging request different from the battery charging request, third integrated representation information through the agent pooling module; and finally, using a self-supervised contrastive learning loss as the second loss, the self-supervised contrastive learning loss being determined according to the first integrated representation information, the second integrated representation information, and the third integrated representation information.

In this implementation, a problem required to be solved is how to train the above agent pooling module to obtain an effective large-scale agent potential representation through the trained agent pooling module. A simple method is to update the agent pooling module through the optimization goal of the reinforcement learning. However, the reinforcement learning algorithm optimizes the policy of the agent through the feedback reward of the environment, which is much more difficult to be controlled than the supervised learning. It is conceivable that it is very difficult for the reinforcement learning to learn effective potential representations from high dimensional inputs. Here, this implementation proposes a contrastive learning objective as an auxiliary task to promote the learning of the agent pooling module for the representations of a large scale of agents.

As an example, with the location lₜ of the battery charging request qₜ as a center, the environment state information and the target operational information corresponding to the top-k_{c} charging stations closest to the location lₜ are selected to constitute x_{q}. As shown in FIG. 5, the process of selecting an agent seems like a process of intercepting a sub-region 501 from the map. Then, the first integrated representation information H_{q} is obtained through the following formula:

H_{q}=AP(x_{q}).

Similarly, a charging station feature subset x₊ of the positive instance H₊ may be obtained by selecting randomly a location from the same X_{D} as H_{q} as a center to intercept top-k_{c} charging stations closest to the center. Here, a plurality of different negative instances may be determined, and the agent feature subset x₋ⁱ of the negative instance H₋ⁱ is intercepted from X_{D} corresponding to another battery charging request (e.g., battery charging requests qₜ₋₁ and qₜ₋₂) different from the battery charging request qₜ in the same way as described above. H₊ and H₋ⁱ are also obtained by respectively performing an agent pooling operation on x₊ and x₋ⁱ.

Similarly, the second integrated representation information H₊ and the third integrated representation information H₋ⁱ are obtained through the following formulas:

H₊=AP(x₊)

H₋ⁱ=AP(x₋ⁱ)

Then, our contrastive learning objective is optimized using the InfoNCloss,

$${L}_{c} = - log \frac{exp ( {H}_{q}^{⊤} {W}_{c} {H}_{+} )}{exp ( {H}_{q}^{⊤} {W}_{c} {H}_{+} ) + {\sum }_{i = 1}^{K - 1} exp ( {H}_{q}^{⊤} {W}_{c} {H}_{-}^{i} )} .$$

Here, W_{c} is a learnable parameter in the agent pooling module. The second loss L_{c} is used as an auxiliary task to perform a joint optimization together with the reinforcement learning objective.

In this implementation, the loss of the agent pooling module is determined through the self-supervised contrastive learning method, which reduces the training difficulty and improves the training efficiency as compared with the policy of optimizing the agent through the feedback reward of the environment by using the reinforcement learning algorithm.

In some alternative implementations of this embodiment, the above executing body may perform the above first step to obtain the first loss by:

first, determining, through a preset reward function, reward information according to a battery charging behavior of a charging object corresponding to the battery charging request, wherein the each charging station in the charging station set shares the reward information, and the preset reward function provides a different reward for a different battery charging behavior; and then, determining, through the temporal difference method, the first loss corresponding to the initial value network according to the cumulative reward expectation corresponding to the battery charging request, a reward corresponding to the battery charging request, and a cumulative reward expectation corresponding to another battery charging request next to the battery charging request.

In this implementation, a delayed reward design is proposed. Here, if the rechargeable vehicle corresponding to qₜ does not head for the controlled charging station (charging station in the charging station set) for battery charging, the reward returned by the environment is 0. If the rechargeable vehicle corresponding to the battery charging request qₜ does not head for the controlled charging station (charging station in the charging station set) for charging, the reward returned by the environment is 0. If the rechargeable vehicle corresponding to the charging request qₜ is drawn by the charging station to choose to charge, but the battery charging fails, the environment returns a relatively small reward ∈. If the rechargeable vehicle corresponding to qₜ is eventually successfully charged at the charging station, the environment will additionally return a unit profit pₜ (charging unit-price−electricity unit-price) as an additional reward.

$${r}_{t} = \{ \begin{matrix}ϵ + {p}_{t} , & Successfully charged \\ ϵ , & Unsuccessfully charged \\ 0 , & Not going to charge\end{matrix}$$

Also, in this implementation, all the charging stations in the charging station set share the same award to encourage the charging stations to cooperate with each other to maximize the total profit.

Further, the first loss is determined through the following formula:

L(θ^{Q})= [symbol] ₒ_{ₜ}_{,A}_{ₜ}_{,O}_{ₜ₊₁}_{,r}_{ₜ}_{˜D}[(Q(Hₜ)−yₜ)²]

yₜ=rₜ+γQ(Hₜ₊₁)|ₐ_{ₜ₊₁}_{ⁱ}₌ᵤ₍ₒ_{ₜ₊₁}_{ⁱ}₎

Here, θ^{Q} denotes a parameter of a value function; Q(Hₜ) denotes a cumulative reward expectation corresponding to the battery charging request qₜ determined by the value function Q according to the integrated representation information Hₜ; yₜ denotes a TD target (temporal difference target); rₜ denotes a reward corresponding to the battery charging request qₜ; Q(Hₜ₊₁) denotes a cumulative reward expectation corresponding to a next battery charging request; y denotes a discount rate; and aₜ₊₁ⁱ=u(oₜ₊₁ⁱ) denotes that the policy network u obtains the target operational information aₜ₊₁ⁱ according to the environment state information oₜ₊₁ⁱ of the next battery charging request corresponding to the charging station cⁱ.

In this implementation, the rewards corresponding to different battery charging requests are determined through the designed preset reward function, and then the first loss is determined according to the temporal difference method, thereby improving the accuracy of the first loss. The reward obtained through the preset reward function is shared among the charging stations in the charging station set, which helps to encourage the charging stations to cooperate with each other to improve the collaboration among the charging stations.

In this implementation, the above executing body may determine the weighted sum of the first loss and the second loss through the following formula:

L(θ^{Q}, θ^{P})= [symbol] ₒ_{ₜ}_{,A}_{ₜ}_{,O}_{ₜ₊₁}_{,r}_{ₜ}_{˜D}[(Q(Hₜ)−yₜ)²]+λL_{c}

Here, θ^{P} denotes a parameter of the agent pooling module, and λ denotes a weighted term of the second loss L_{c}.

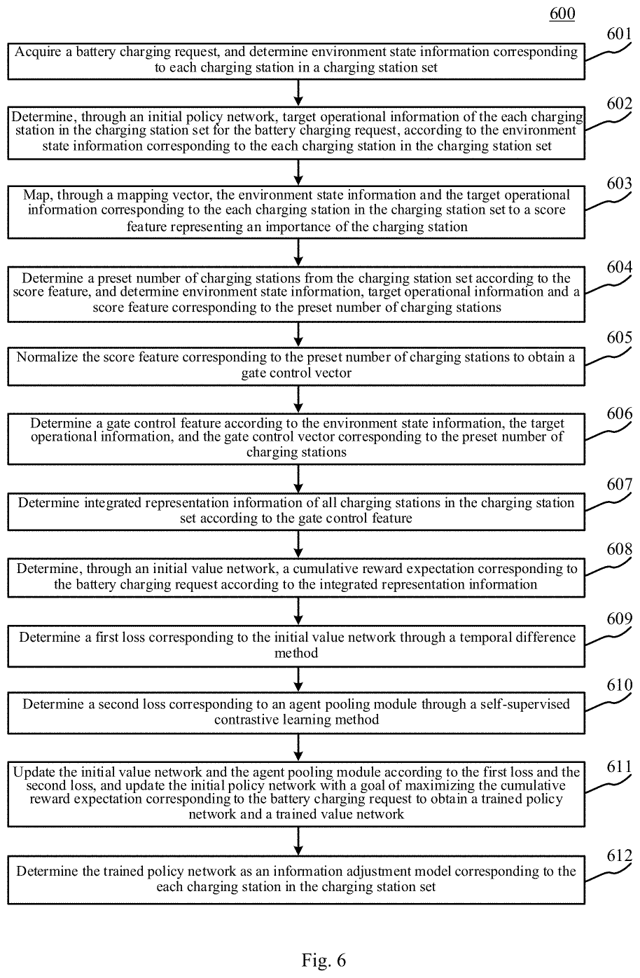

Further referring to FIG. 6, FIG. 6 illustrates a schematic flow 600 of a method for training an information adjustment model of a charging station according to another embodiment of the present disclosure, which includes the following steps:

Step 601, acquiring a battery charging request, and determining environment state information corresponding to each charging station in a charging station set.

Step 602, determining, through an initial policy network, target operational information of the each charging station in the charging station set for the battery charging request, according to the environment state information corresponding to the each charging station in the charging station set.

Step 603, mapping, through a mapping vector, the environment state information and the target operational information corresponding to the each charging station in the charging station set to a score feature representing an importance of the each charging station.

Step 604, determining a preset number of charging stations from the charging station set according to the score feature, and determining environment state information, target operational information and a score feature corresponding to the preset number of charging stations.

Step 605, normalizing the score feature corresponding to the preset number of charging stations to obtain a gate control vector.

Step 606, determining a gate control feature according to the environment state information, the target operational information, and the gate control vector corresponding to the preset number of charging stations.

Step 607, determining integrated representation information of all charging stations in the charging station set according to the gate control feature.

Step 608, determining, through an initial value network, a cumulative reward expectation corresponding to the battery charging request according to the integrated representation information.

Step 609, determining a first loss corresponding to the initial value network through a temporal difference method.

Step 610, determining a second loss corresponding to an agent pooling module through a self-supervised contrastive learning method.

Step 611, updating the initial value network and the agent pooling module according to the first loss and the second loss, and updating the initial policy network with a goal of maximizing the cumulative reward expectation corresponding to the charging request to obtain a trained policy network and a trained value network.

Step 612, determining the trained policy network as an information adjustment model corresponding to the each charging station in the charging station set.

It can be seen from this embodiment that, as compared with the embodiment corresponding to FIG. 2, the flow 600 of the method for training an information adjustment model of a charging station in this embodiment describes the processing process of the agent pooling module and the multi-agent reinforcement learning process in detail, the coordination among the charging stations in the charging station set is further improved, thereby improving the real-time performance and rationality of the charging station in determining the target operational information.

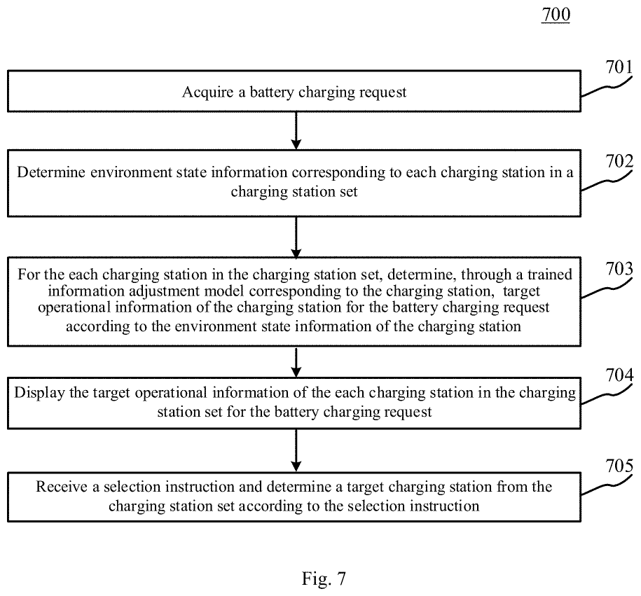

Further referring to FIG. 7, FIG. 7 illustrates a schematic flow 700 of a method for selecting a charging station according to an embodiment of the present disclosure, which includes the following steps:

Step 701, acquiring a battery charging request.

In this embodiment, an executing body (e.g., the terminal device or the server in FIG. 1) of the method for selecting a charging station may acquire, by means of a wired network connection or wireless network connection, the battery charging request remotely or locally.

The battery charging request may be a request that is sent by a user in a rechargeable vehicle through a terminal device such as a smartphone or a vehicle-mounted computer, and represents that the rechargeable vehicle needs to be charged. When the rechargeable vehicle has a battery charging demand, a corresponding user such as a driver or a passenger will initiate a battery charging request at a charging platform. A battery charging request qₜ is defined as a t-th request in one day. The battery charging request qₜ includes the following attributes: the location lₜ at which qₜ is sent, and the time Tₜ at which qₜ is sent.

Step 702, determining environment state information corresponding to each charging station in a charging station set.

In this embodiment, the above executing body may determine the environment state information corresponding to a target charging station.

The charging station set includes a plurality of charging stations. As an example, the charging station set refers to all charging stations in a preset partitioned region (e.g., obtained by partitioning according to administrative regions or according to specified areas). Each charging station may be regarded as an agent. A charging station set C includes N charging stations cⁱ ∈ C. For a battery charging request, the location ranges of all charging stations in the charging station set corresponding to the battery charging request include the location at which the battery charging request is sent.

For each charging station cⁱ, the environment state information of the charging station relative to the battery charging request qₜ may be considered as an observation for the charging station cⁱ, including information representing the charging station cⁱ and information representing a correlation between the battery charging request qₜ and the charging station cⁱ. As an example, for the battery charging request qₜ, the environment state information of the charging station cⁱ includes: current time Tₜ, the number of current idle charging spots at the charging station cⁱ, the number of charging requests in a future preset time period (e.g., 15 minutes) in the vicinity of the charging station cⁱ (a trained prediction model may be used to predict the number of battery charging requests in the future), the estimated traveling time from the location of a current battery charging request to the charging station cⁱ, the charging power of the charging station cⁱ, a current electricity unit-price of cⁱ, and the number of rechargeable vehicles that are heading for cⁱ (which can be acquired through a charging platform application).

Step 703, for the each charging station in the charging station set, determining, through a trained information adjustment model corresponding to the each charging station, target operational information of the each charging station for the battery charging request according to the environment state information of the charging station.

In this embodiment, for each charging station in the charging station set, the above executing body may determine the target operational information of the charging station for the battery charging request according to the environment state information of the charging station, through the trained information adjustment model corresponding to the charging station. Here, on the basis that the charging stations in the charging station set perceive the environment state information of each other, the information adjustment model is obtained by performing multi-agent reinforcement learning based on a deep deterministic policy gradient algorithm. Here, the information adjustment model is trained through the above embodiments 200 and 600.

As an example, for a target charging station cⁱ ∈ C, the real-time target operational information is generated in parallel according to the environment state information oₜⁱ and information adjustment model u of the charging station:

aₜⁱ=u(oₜⁱ).

Here, an action aₜⁱ is the target operational information generated in real time by the charging station for qₜ.

Step 704, displaying the target operational information of the each charging station in the charging station set for the battery charging request.

In this embodiment, the above executing body may display the target operational information of the each charging station in the charging station set for the battery charging request.

As an example, through the charging platform, the target operational information of each charging station in the charging station set for the battery charging request may be display to the user who sends the battery charging request.

Step 705, receiving a selection instruction and determining a target charging station from the charging station set according to the selection instruction.

As an example, the user who sends the battery charging request may select an appropriate charging station as the target charging station according to the displayed target operational information of each charging station, and may give the selection instruction by means of an action instruction such as a touch or a click, or a voice instruction, and thus, the above executing body may determine the target charging station according to the selection instruction.

After determining the target charging station, the above executing body may further perform a navigation operation from a current location to the target charging station based on a navigation application.

In this embodiment, the target operational information is determined in real time for the charging station through the trained information adjustment model, which improves the real-time performance and rationality of the target operational information. At the same time, the coordination among the charging stations in the charging station set is improved, which helps to solve the problem of uncoordinated battery charging among the charging stations, thereby improving the utilization rate of the charging stations.

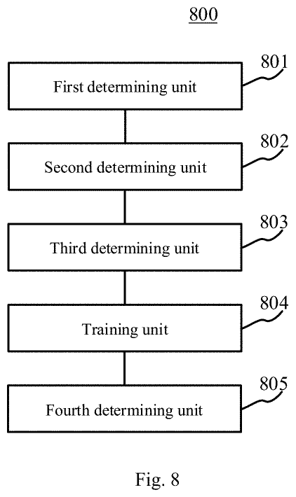

Further referring to FIG. 8, as an implementation of the method shown in the above drawings, an embodiment of the present disclosure provides an apparatus for training an information adjustment model of a charging station. The embodiment of the apparatus corresponds to the embodiment of the method shown in FIG. 2, and the apparatus may be applied in various electronic devices.

As shown in FIG. 8, an apparatus 800 for training an information adjustment model of a charging station includes: a first determining unit 801, configured to acquire a battery charging request, and determine environment state information corresponding to each charging station in a charging station set; a second determining unit 802, configured to determine, through an initial policy network, target operational information of the each charging station in the charging station set for the battery charging request, according to the environment state information corresponding to the each charging station in the charging station set; a third determining unit 803, configured to determine, through an initial value network, a cumulative reward expectation corresponding to the battery charging request according to the environment state information and the target operational information corresponding to the each charging station in the charging station set; a training unit 804, configured to train the initial policy network and the initial value network by using a deep deterministic policy gradient algorithm, to obtain a trained policy network and a trained value network, wherein, during the training, the initial value network is updated through a temporal difference method, and the initial policy network is updated with a goal of maximizing the cumulative reward expectation corresponding to the battery charging request; and a fourth determining unit 805, configured to determine the trained policy network as an information adjustment model corresponding to the each charging station in the charging station set.

In some alternative implementations of this embodiment, the third determining unit 803 is further configured to: determine, through an agent pooling module, integrated representation information representing all charging stations in the charging station set according to the environment state information and the target operational information corresponding to the each charging station in the charging station set; and determine, through the initial value network, the cumulative reward expectation corresponding to the battery charging request according to the integrated representation information.

In some alternative implementations of this embodiment, the third determining unit 803 is further configured to: map, through a mapping vector, the environment state information and the target operational information corresponding to the each charging station in the charging station set to a score feature representing an importance of the each charging station; determine a preset number of charging stations from the charging station set according to the score feature, and determine environment state information, target operational information and a score feature corresponding to the preset number of charging stations; normalize the score feature corresponding to the preset number of charging stations to obtain a gate control vector; determine a gate control feature according to the environment state information, the target operational information and the gate control vector corresponding to the preset number of charging stations; and determine the integrated representation information of all the charging stations in the charging station set according to the gate control feature.

In some alternative implementations of this embodiment, the training unit 804 is further configured to: determine a first loss corresponding to the initial value network through the temporal difference method; determine a second loss corresponding to the agent pooling module through a self-supervised contrastive learning method; update the initial value network and the agent pooling module according to the first loss and the second loss; and update the initial policy network with the goal of maximizing the cumulative reward expectation corresponding to the battery charging request.

In some alternative implementations of this embodiment, the training unit 804 is further configured to: determine, for a first subset in a joint feature, first integrated representation information through the agent pooling module, wherein the joint feature comprises the environment state information and the target operational information corresponding to the each charging station in the charging station set; determine, for a second subset in the joint feature, second integrated representation information through the agent pooling module; determine, for a third subset in a joint feature corresponding to another battery charging request different from the battery charging request, third integrated representation information through the agent pooling module; and use a self-supervised contrastive learning loss as the second loss, the self-supervised contrastive learning loss being determined according to the first integrated representation information, the second integrated representation information and the third integrated representation information.

In some alternative implementations of this embodiment, the training unit 804 is further configured to: determine, through a preset reward function, reward information according to a battery charging behavior of a charging object corresponding to the battery charging request, wherein the each charging station in the charging station set shares the reward information, and the preset reward function provides a different reward for a different battery charging behavior; and determine, through the temporal difference method, the first loss corresponding to the initial value network according to the cumulative reward expectation corresponding to the battery charging request, a reward corresponding to the battery charging request, and a cumulative reward expectation corresponding to a battery charging request next to the battery charging request.

In this embodiment, an apparatus for training an information adjustment model of a charging station is provided. A charging station is used as an agent, and multi-agent reinforcement learning is performed based on a deep deterministic policy gradient algorithm, to train and obtain a policy network that can determine target operational information in real time as an information adjustment model, thereby improving the real-time performance and rationality of the charging station in determining the target operational information. In the model training phase, the goal is to maximize the cumulative reward of the charging station set as a whole, and thus the agents can perceive each other and the whole environment information, which improves the coordination among the charging stations in the charging station set and helps to solve the problem of uncoordinated charging among the charging stations, thereby improving the utilization rate of the charging stations.

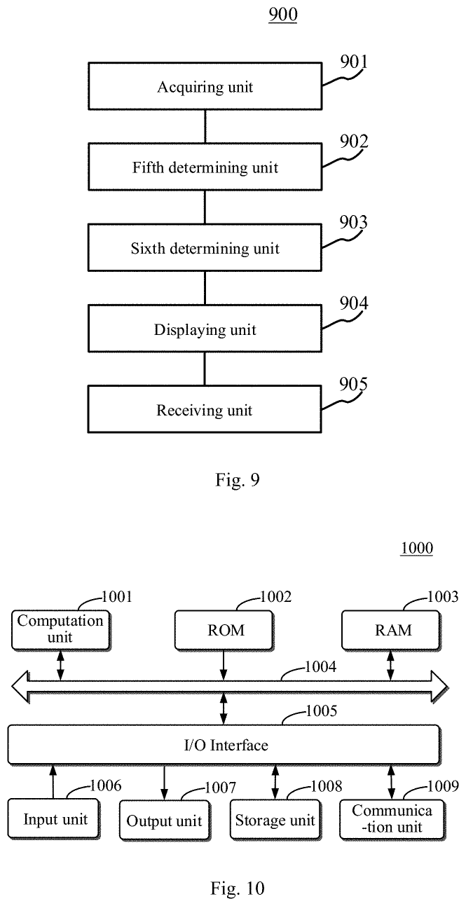

Further referring to FIG. 9, as an implementation of the method shown in the above drawings, an embodiment of the present disclosure provides an apparatus for selecting a charging station. The embodiment of the apparatus corresponds to the embodiment of the method shown in FIG. 7, and the apparatus may be applied in various electronic devices.

As shown in FIG. 9, an apparatus 900 for selecting a charging station includes: an acquiring unit 901, configured to acquire a battery charging request; a fifth determining unit 902, configured to determine environment state information corresponding to each charging station in a charging station set; a sixth determining unit 903, configured to determine through a trained information adjustment model corresponding to the each charging station, for the each charging station in the charging station set, target operational information of the each charging station for the battery charging request according to the environment state information of the charging station, wherein, on a basis that charging stations in the charging station set perceive environment state information of each other, the trained information adjustment model is obtained by performing multi-agent reinforcement learning based on a deep deterministic policy gradient algorithm; a displaying unit 904, configured to display the target operational information of the each charging station in the charging station set for the battery charging request; and a receiving unit 905, configured to receive a selection instruction and determine a target charging station from the charging station set according to the selection instruction.

In this embodiment, the target operational information is determined in real time for the charging station through the trained information adjustment model, which improves the real-time performance and rationality of the target operational information. At the same time, the coordination among the charging stations in the charging station set is improved, which helps to solve the problem of uncoordinated battery charging among the charging stations, thereby improving the utilization rate of the charging stations.

According to an embodiment of the present disclosure, an electronic device is provided. The electronic device includes at least one processor, and a storage device in communication with the at least one processor. Here, the storage device stores instructions executable by the at least one processor, and the instructions are executed by the at least one processor, to enable the at least one processor to implement the method for training an information adjustment model of a charging station and/or the method for selecting a charging station described in any of the above embodiments.

According to an embodiment of the present disclosure, a readable storage medium is provided. The readable storage medium stores a computer instruction. Here, the computer instruction is used to enable a computer to implement the method for training an information adjustment model of a charging station and/or the method for selecting a charging station described in any of the above embodiments.

An embodiment of the present disclosure provides a computer program product. The computer program, when executed by a processor, can implement the method for training an information adjustment model of a charging station and/or the method for selecting a charging station described in any of the above embodiments.

FIG. 10 is a schematic block diagram of an example electronic device 1000 that may be used to implement embodiments of the present disclosure. The electronic device is intended to represent various forms of digital computers such as a laptop computer, a desktop computer, a workstation, a personal digital assistant, a server, a blade server, a mainframe computer, and other appropriate computers. The electronic device may alternatively represent various forms of mobile apparatuses such as personal digital processing, a cellular telephone, a smart phone, a wearable device and other similar computing apparatuses. The parts shown herein, their connections and relationships, and their functions are only as examples, and not intended to limit implementations of the present disclosure as described and/or claimed herein.

As shown in FIG. 10, the device 1000 includes a computation unit 1001, which may execute various appropriate actions and processes in accordance with a program stored in a read-only memory (ROM) 1002 or a program loaded into a random access memory (RAM) 1003 from a storage portion 1008. The RAM 1003 also stores various programs and data required by operations of the device 1000. The computation unit 1001, the ROM 1002 and the RAM 1003 are connected to each other through a bus 1004. An input/output (I/O) interface 1005 is also connected to the bus 1004.

The following components are connected to the I/O interface 1005: an input unit 1006 including a keyboard, a mouse etc.; an output unit 1007 comprising various types of display device, a speaker etc.; a storage unit 1008 including a disk, an optical disk, and the like; and a communication unit 1009, such as a network card, a modem, a wireless communication transceiver, etc. The communication unit 1009 allows the device 1000 to exchange information/data with other devices through a computer network such as the internet and/or various telecommunication networks.

The computation unit 1001 may be various general-purpose and/or dedicated processing components having processing and computing capabilities. Some examples of the computation unit 1001 include, but are not limited to, central processing unit (CPU), graphics processing unit (GPU), various dedicated artificial intelligence (AI) computing chips, various computation units running machine learning model algorithms, digital signal processors (DSP), and any appropriate processors, controllers, microcontrollers, etc. The computation unit 1001 performs the various methods and processes described above, such as the method for training an information adjustment model of a charging station. For example, in some embodiments, the method for training an information adjustment model of a charging station may be implemented as a computer software program, which is tangibly included in a machine readable medium, such as the storage unit 1008. In some embodiments, part or all of the computer program may be loaded and/or installed on the device 1000 via the ROM 1002 and/or the communication unit 1009. When the computer program is loaded into the RAM 1003 and executed by the computation unit 1001, one or more steps of the method for training an information adjustment model of a charging station may be performed. Alternatively, in other embodiments, the computation unit 1001 may be configured to perform the method for training an information adjustment model of a charging station by any other appropriate means (for example, by means of firmware).

Various systems and technologies described above in embodiments of the present disclosure can be implemented in digital electronic circuit systems, integrated circuit systems, field programmable gate arrays (FPGAs), application specific integrated circuits (ASIC), application specific standard products (ASSP), system on chip (SOC), load programmable logic devices (CPLD), computer hardware, firmware, software, and/or combinations thereof. These various embodiments may include: being implemented in one or more computer programs, the one or more computer programs can be executed and/or interpreted on a programmable system including at least one programmable processor, which can be a special-purpose or general-purpose programmable processor, and can receive data and instructions from the storage system, at least one input device, and at least one output device, and transmitting data and instructions to the storage system, the at least one input device, and the at least one output device.

The program code for implementing the methods described in embodiments of the present disclosure may be written in any combination of one or more programming languages. These program codes can be provided to the processor or controller of general-purpose computer, special-purpose computer or other programmable data processing device, so that when the program code is executed by the processor or controller, the functions/operations specified in the flow chart and/or block diagram are implemented. The program code can be completely executed on the machine, partially executed on the machine, partially executed on the machine and partially executed on the remote machine as a separate software package, or completely executed on the remote machine or server.

In the context of the present disclosure, a machine-readable medium may be a tangible medium that may contain or store a program for use by or in combination with an instruction execution system, apparatus, or device. The machine-readable medium can be a machine-readable signal medium or a machine-readable storage medium. Machine readable media may include, but are not limited to, electronic, magnetic, optical, electromagnetic, infrared, or semiconductor systems, apparatuses, or devices, or any suitable combination of the foregoing. More specific examples of machine-readable storage media may include one or more wire based electrical connections, portable computer disks, hard disks, random access memory (RAM), read only memory (ROM), erasable programmable read only memory (EPROM or flash memory), optical fibers, compact disk read only memory (CD-ROM), optical storage devices, magnetic storage devices, or any suitable combination of the above.

In order to provide interaction with users, the systems and techniques described herein can be implemented on a computer with: a display device for displaying information to users (for example, a CRT (cathode ray tube) or LCD (liquid crystal display) monitor); and a keyboard and a pointing device (e.g., a mouse or a trackball) through which the user can provide input to the computer. Other kinds of devices can also be used to provide interaction with users. For example, the feedback provided to the user may be any form of sensor feedback (e.g., visual feedback, auditory feedback, or tactile feedback); and the input from the user can be received in any form (including acoustic input, voice input or tactile input).

The systems and techniques described herein may be implemented in a computing system including background components (e.g., as a data server), or a computing system including middleware components (e.g., an application server) or a computing system including a front-end component (e.g., a user computer with a graphical user interface or a web browser through which a user can interact with embodiments of the systems and techniques described herein), or a computing system including any combination of the back-end component, the middleware component, the front-end component. The components of the system can be interconnected by digital data communication (e.g., communication network) in any form or medium. Examples of communication networks include local area networks (LANs), wide area networks (WANs), and the Internet.

A computer system may include a client and a server. The client and the server are generally far away from each other and usually interact through communication networks. The relationship between the client and the server is generated by computer programs running on the corresponding computers and having a client server relationship with each other. The server can be a cloud server, also known as cloud computing server or virtual machine, which is a host product in the cloud computing service system, to solve the defects of the traditional physical host and virtual private server (VPS, Virtual Private Server) services, such as high management difficulty and weak service scalability. The server may also be a server of a distributed system or a server combined with a blockchain.

According to the technical solution of the embodiment of the present disclosure, a method for training an information adjustment model of a charging station is provided. A charging station is used as an agent, and multi-agent reinforcement learning is performed based on a deep deterministic policy gradient algorithm, to train and obtain a policy network that can determine target operational information in real time as an information adjustment model, thereby improving the real-time performance and rationality of the charging station in determining the target operational information. In the model training phase, the goal is to maximize the cumulative reward of the charging station set as a whole, and thus the agents can perceive each other and the whole environment information, which improves the coordination among the charging stations in the charging station set and helps to solve the problem of uncoordinated battery charging among the charging stations, thereby improving the utilization rate of the charging stations.

It should be understood that various forms of processes shown above can be used to reorder, add or delete steps. For example, the steps recorded in embodiments of the present disclosure can be performed in parallel, in sequence, or in different orders, as long as the desired results of the technical solution of the present disclosure can be achieved, which is not limited herein.

The above specific embodiments do not constitute restrictions on the scope of the present disclosure. Those skilled in the art should understand that various modifications, combinations, sub combinations and substitutions can be made according to design requirements and other factors. Any modification, equivalent replacement and improvement made within the spirit and principles of this disclosure shall be included in the scope of protection of this disclosure.

What is claimed is:

1. A method for training an information adjustment model of a charging station, comprising:
acquiring a battery charging request, and determining an environment state information corresponding to each charging station in a charging station set;
determining, through an initial policy network, target operational information of each charging station in the charging station set for the battery charging request, according to the environment state information corresponding to each charging station in the charging station set;
determining, through an initial value network, a cumulative reward expectation corresponding to the battery charging request according to the environment state information and the target operational information corresponding to each charging station in the charging station set;
training the initial policy network and the initial value network by using a deep deterministic policy gradient algorithm, to obtain a trained policy network and a trained value network, wherein, during the training, the initial value network is updated through a temporal difference method, and the initial policy network is updated with a goal of maximizing the cumulative reward expectation corresponding to the battery charging request; and
determining the trained policy network as an information adjustment model corresponding to each charging station in the charging station set.

2. The method according to claim 1, wherein determining, through the initial value network, the cumulative reward expectation corresponding to the battery charging request according to the environment state information and the target operational information corresponding to each charging station in the charging station set comprises:
determining, through an agent pooling module, integrated representation information representing all charging stations in the charging station set according to the environment state information and the target operational information corresponding to each charging station in the charging station set; and
determining, through the initial value network, the cumulative reward expectation corresponding to the battery charging request according to the integrated representation information.

3. The method according to claim 2, wherein determining, through the agent pooling module, integrated representation information representing all charging stations in the charging station set according to the environment state information and the target operational information corresponding to each charging station in the charging station set comprises:
mapping, through a mapping vector, the environment state information and the target operational information corresponding to each charging station in the charging station set to a score feature representing an importance of each charging station;
determining a preset number of charging stations from the charging station set according to the score feature, and determining the environment state information, the target operational information and the score feature corresponding to each charging station of the preset number of charging stations;
normalizing score features corresponding to the preset number of charging stations to obtain a gate control vector;
determining a gate control feature according to the environment state information, the target operational information, and the gate control vector corresponding to the preset number of charging stations; and
determining the integrated representation information of all the charging stations in the charging station set according to the gate control feature.

4. The method according to claim 2, wherein training the initial policy network and the initial value network by using the deep deterministic policy gradient algorithm comprises:
determining a first loss corresponding to the initial value network through the temporal difference method;
determining a second loss corresponding to the agent pooling module through a self-supervised contrastive learning method;
updating the initial value network and the agent pooling module according to the first loss and the second loss; and
updating the initial policy network with the goal of maximizing the cumulative reward expectation corresponding to the battery charging request.

5. The method according to claim 4, wherein determining the second loss corresponding to the agent pooling module through the self-supervised contrastive learning method comprises:
determining, for a first subset in a joint feature, first integrated representation information through the agent pooling module, wherein the joint feature comprises the environment state information and the target operational information corresponding to each charging station in the charging station set;
determining, for a second subset in the joint feature, second integrated representation information through the agent pooling module;
determining, for a third subset in the joint feature corresponding to another battery charging request different from the battery charging request, third integrated representation information through the agent pooling module; and
using a self-supervised contrastive learning loss as the second loss, the self-supervised contrastive learning loss being determined according to the first integrated representation information, the second integrated representation information, and the third integrated representation information.

6. The method according to claim 4, wherein determining the first loss corresponding to the initial value network through the temporal difference method comprises:
determining, through a preset reward function, reward information according to a battery charging behavior of a charging object corresponding to the battery charging request, wherein each charging station in the charging station set shares the reward information, and the preset reward function provides a different reward for a different battery charging behavior; and
determining, through the temporal difference method, the first loss corresponding to the initial value network according to the cumulative reward expectation corresponding to the battery charging request, a reward corresponding to the battery charging request, and a cumulative reward expectation corresponding to a second battery charging request next to the battery charging request.

7. The method according to claim 1, further comprising:
acquiring a new battery charging request;
determining the environment state information corresponding to each charging station in the charging station set;
for each charging station in the charging station set, determining, through the information adjustment model corresponding to each charging station, target operational information of each charging station for the new battery charging request according to the environment state information of the charging station, wherein each charging station in the charging station set is configured to perceive the environment state information of each other, and the information adjustment model is obtained by performing multi-agent reinforcement learning based on the deep deterministic policy gradient algorithm;
displaying the target operational information of each charging station in the charging station set for the new battery charging request; and
receiving a selection instruction and determining a target charging station from the charging station set according to the selection instruction.

8. An apparatus for training an information adjustment model of a charging station, comprising:
at least one processor; and
a storage device, in communication with the at least one processor,
wherein the storage device stores instructions which, when executed by the at least one processor, cause the at least one processor to perform operations comprising:
acquiring a battery charging request, and determining an environment state information corresponding to each charging station in a charging station set;
determining, through an initial policy network, target operational information of each charging station in the charging station set for the battery charging request, according to the environment state information corresponding to each charging station in the charging station set;
determining, through an initial value network, a cumulative reward expectation corresponding to the battery charging request according to the environment state information and the target operational information corresponding to each charging station in the charging station set;
training the initial policy network and the initial value network by using a deep deterministic policy gradient algorithm, to obtain a trained policy network and a trained value network, wherein, during the training, the initial value network is updated through a temporal difference method, and the initial policy network is updated with a goal of maximizing the cumulative reward expectation corresponding to the battery charging request; and
determining the trained policy network as an information adjustment model corresponding to each charging station in the charging station set.

9. The apparatus according to claim 8, wherein determining, through the initial value network, the cumulative reward expectation corresponding to the battery charging request according to the environment state information and the target operational information corresponding to each charging station in the charging station set comprises:
determining, through an agent pooling module, integrated representation information representing all charging stations in the charging station set according to the environment state information and the target operational information corresponding to each charging station in the charging station set; and
determining, through the initial value network, the cumulative reward expectation corresponding to the battery charging request according to the integrated representation information.

10. The apparatus according to claim 9, wherein determining, through the agent pooling module, integrated representation information representing all charging stations in the charging station set according to the environment state information and the target operational information corresponding to each charging station in the charging station set comprises:
mapping, through a mapping vector, the environment state information and the target operational information corresponding to each charging station in the charging station set to a score feature representing an importance of each charging station;
determining a preset number of charging stations from the charging station set according to the score feature, and determining the environment state information, the target operational information, and the score feature corresponding to each charging station of the preset number of charging stations;
normalizing score features corresponding to the preset number of charging stations to obtain a gate control vector;
determining a gate control feature according to the environment state information, the target operational information, and the gate control vector corresponding to the preset number of charging stations; and
determining the integrated representation information of all the charging stations in the charging station set according to the gate control feature.

11. The apparatus according to claim 9, wherein training the initial policy network and the initial value network by using the deep deterministic policy gradient algorithm comprises:
determining a first loss corresponding to the initial value network through the temporal difference method;
determining a second loss corresponding to the agent pooling module through a self-supervised contrastive learning method;
updating the initial value network and the agent pooling module according to the first loss and the second loss; and
updating the initial policy network with the goal of maximizing the cumulative reward expectation corresponding to the battery charging request.

12. The apparatus according to claim 11, wherein determining the second loss corresponding to the agent pooling module through the self-supervised contrastive learning method comprises:
determining, for a first subset in a joint feature, first integrated representation information through the agent pooling module, wherein the joint feature comprises the environment state information and the target operational information corresponding to each charging station in the charging station set;
determining, for a second subset in the joint feature, second integrated representation information through the agent pooling module;
determining, for a third subset in the joint feature corresponding to another battery charging request different from the battery charging request, third integrated representation information through the agent pooling module; and
using a self-supervised contrastive learning loss as the second loss, the self-supervised contrastive learning loss being determined according to the first integrated representation information, the second integrated representation information and the third integrated representation information.

13. The apparatus according to claim 11, wherein determining the first loss corresponding to the initial value network through the temporal difference method comprises:
determining, through a preset reward function, reward information according to a battery charging behavior of a charging object corresponding to the battery charging request, wherein each charging station in the charging station set shares the reward information, and the preset reward function provides a different reward for a different battery charging behavior; and
determining, through the temporal difference method, the first loss corresponding to the initial value network according to the cumulative reward expectation corresponding to the battery charging request, a reward corresponding to the battery charging request, and a cumulative reward expectation corresponding to a second battery charging request next to the battery charging request.

14. The apparatus according to claim 8, wherein the operations further comprise:
acquiring a new battery charging request;
determining the environment state information corresponding to each charging station in the charging station set;
for each charging station in the charging station set, determining, through the information adjustment model corresponding to each charging station, target operational information of each charging station for the new battery charging request according to the environment state information of the charging station, wherein each charging station in the charging station set is configured to perceive the environment state information of each other, and the information adjustment model is obtained by performing multi-agent reinforcement learning based on the deep deterministic policy gradient algorithm;
displaying the target operational information of each charging station in the charging station set for the new battery charging request; and
receiving a selection instruction and determining a target charging station from the charging station set according to the selection instruction.

15. A non-transitory computer readable storage medium, storing executable instructions, wherein the executable instructions are used to cause a computer to perform operations comprising:
acquiring a battery charging request, and determining an environment state information corresponding to each charging station in a charging station set;
determining, through an initial policy network, target operational information of each charging station in the charging station set for the battery charging request, according to the environment state information corresponding to each charging station in the charging station set;
determining, through an initial value network, a cumulative reward expectation corresponding to the battery charging request according to the environment state information and the target operational information corresponding to each charging station in the charging station set;
training the initial policy network and the initial value network by using a deep deterministic policy gradient algorithm, to obtain a trained policy network and a trained value network, wherein, during the training, the initial value network is updated through a temporal difference method, and the initial policy network is updated with a goal of maximizing the cumulative reward expectation corresponding to the battery charging request; and
determining the trained policy network as an information adjustment model corresponding to each charging station in the charging station set.

16. The non-transitory computer readable storage medium according to claim 15, wherein determining, through the initial value network, the cumulative reward expectation corresponding to the battery charging request according to the environment state information and the target operational information corresponding to each charging station in the charging station set comprises:
determining, through an agent pooling module, integrated representation information representing all charging stations in the charging station set according to the environment state information and the target operational information corresponding to each charging station in the charging station set; and
determining, through the initial value network, the cumulative reward expectation corresponding to the battery charging request according to the integrated representation information.

17. The non-transitory computer readable storage medium according to claim 16, wherein determining, through the agent pooling module, integrated representation information representing all charging stations in the charging station set according to the environment state information and the target operational information corresponding to each charging station in the charging station set comprises:
mapping, through a mapping vector, the environment state information and the target operational information corresponding to each charging station in the charging station set to a score feature representing an importance of each charging station;
determining a preset number of charging stations from the charging station set according to the score feature, and determining the environment state information, the target operational information, and the score feature corresponding to each charging station of the preset number of charging stations;
normalizing score features corresponding to the preset number of charging stations to obtain a gate control vector;
determining a gate control feature according to the environment state information, the target operational information, and the gate control vector corresponding to the preset number of charging stations; and
determining the integrated representation information of all the charging stations in the charging station set according to the gate control feature.

18. The non-transitory computer readable storage medium according to claim 16, wherein training the initial policy network and the initial value network by using the deep deterministic policy gradient algorithm comprises:
determining a first loss corresponding to the initial value network through the temporal difference method;
determining a second loss corresponding to the agent pooling module through a self-supervised contrastive learning method;
updating the initial value network and the agent pooling module according to the first loss and the second loss; and
updating the initial policy network with the goal of maximizing the cumulative reward expectation corresponding to the battery charging request.

19. The non-transitory computer readable storage medium according to claim 18, wherein determining the second loss corresponding to the agent pooling module through the self-supervised contrastive learning method comprises:
determining, for a first subset in a joint feature, first integrated representation information through the agent pooling module, wherein the joint feature comprises the environment state information and the target operational information corresponding to each charging station in the charging station set;
determining, for a second subset in the joint feature, second integrated representation information through the agent pooling module;
determining, for a third subset in the joint feature corresponding to another battery charging request different from the battery charging request, third integrated representation information through the agent pooling module; and
using a self-supervised contrastive learning loss as the second loss, the self-supervised contrastive learning loss being determined according to the first integrated representation information, the second integrated representation information, and the third integrated representation information.

20. The non-transitory computer readable storage medium according to claim 18, wherein determining the first loss corresponding to the initial value network through the temporal difference method comprises:
determining, through a preset reward function, reward information according to a battery charging behavior of a charging object corresponding to the battery charging request, wherein each charging station in the charging station set shares the reward information, and the preset reward function provides a different reward for a different battery charging behavior; and
determining, through the temporal difference method, the first loss corresponding to the initial value network according to the cumulative reward expectation corresponding to the battery charging request, a reward corresponding to the battery charging request, and a cumulative reward expectation corresponding to a second battery charging request next to the battery charging request.
